(19) United States
(12) Patent Application Publication
(10) Pub. No.: US 2015/0045078 A1
(43) Pub. Date: Feb. 12, 2015

(54) METHOD FOR D2D TERMINAL TRANSMITTING AND RECEIVING DATA IN WIRELESS COMMUNICATION SYSTEM SUPPORTING DEVICE-TO-DEVICE COMMUNICATION

(71) Applicant: LG ELECTRONICS INC., Seoul (KR)

(72) Inventors: Eunjong Lee, Anyang-si (KR); Seunghyun Kang, Anyang-si (KR); Hyeyoung Choi, Anyang-si (KR); Heejeong Cho, Anyang-si (KR); Jaehoon Chung, Anyang-si (KR)

(73) Assignee: LG ELECTRONICS INC., Seoul (KR)

(21) Appl. No.: 14/391,154

(22) PCT Filed: Apr. 9, 2013
(86) PCT No.: PCT/KR2013/002955

§ 371 Date: Oct. 7, 2014

Related U.S. Application Data
(60) Provisional application No. 61/621,583, filed on Apr. 9, 2012.
(60) Provisional application No. 61/654,956, filed on Jun. 4, 2012.

(51) Int. Cl. H04W 76/02

(52) U.S. Cl. CPC H04W 76/021; H04W 76/023
USPC 455/509

(57) ABSTRACT

Disclosed is a method for a device-to-device (D2D) terminal transmitting/receiving data in a wireless communication system supporting D2D communication. The method for the D2D terminal transmitting the data in the wireless communication system supporting D2D communication, comprises the steps of: establishing a link identifier between two D2D terminals and at least one connection identifier between the two D2D terminals; and transmitting the data by including the link identifier and the at least one connection identifier which are established.

### TECHNICAL FIELD

The present invention relates to a wireless communication, and more particularly, to a method for a D2D terminal to transmit and receive data in a wireless communication system supporting direct communication between terminals.

### BACKGROUND ART

Recently, mobile traffic is rapidly increasing as a smartphone and a tablet PC are disseminated and high capacity multimedia communication are vitalizing. The increasing trend of the mobile traffic is expected to be doubled in every year. Since most of the mobile traffic is transmitted via a base station, communication service providers are currently facing with a serious network load problem. Hence, the communication service providers have increased network facilities to process the increasing traffic and have commercialized such a next generation mobile communication standard capable of efficiently processing a large amount of traffic as mobile WiMAX and LTE (long term evolution) in a hurry. Yet, in order to deal with the amount of traffic which is expected to be rapidly increased in the future, it is time to have a further different solution.

A device-to-device (hereinafter abbreviated D2D) communication corresponds to a distributed communication technology directly delivering traffic to adjacent nodes without using such an infrastructure as a base station and the like. In D2D communication environment, each node such as a mobile terminal and the like searches for a physically adjacent different terminal, establishes a communication session and transmits traffic to the different terminal As mentioned above, since the D2D communication can solve a network overload problem in a manner of distributing traffic concentrated to a base station, the D2D communication is in the limelight as an element technology of a next generation mobile communication technology after 4G For this reason, a standard organization such as 3GPP, IEEE and the like is trying to legislate a D2D communication standard based on LTE-A or Wi-Fi. And, Qualcomm and the like are developing a D2D communication technology of their own.

In a D2D system, data are transmitted and received between D2D terminals. In this case, it is necessary to have a method of distinguishing the data from each other. Yet, solutions for solving the aforementioned problems are not proposed yet.

### DISCLOSURE OF THE INVENTION

### Technical Tasks

One technical task intended to achieve by the present invention is to provide a method for a D2D terminal to transmit a data in a wireless communication system supporting device-to-device (D2D) communication.

Another technical task intended to achieve by the present invention is to provide a method for a D2D terminal to receive a data in a wireless communication system supporting device-to-device (D2D) communication.

Another technical task intended to achieve by the present invention is to provide a D2D terminal transmitting a data in a wireless communication system supporting device-to-device (D2D) communication.

The other technical task intended to achieve by the present invention is to provide a D2D terminal receiving a data in a wireless communication system supporting device-to-device (D2D) communication.

Technical tasks obtainable from the present invention are non-limited the above mentioned technical tasks. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, a method of transmitting a data by a D2D terminal in a wireless communication system supporting a device-to-device (D2D) communication, the method includes the steps of establishing a link identifier (link ID) between two D2D terminals and at least one connection identifier between the two D2D terminals and transmitting the data including the established link identifier and the at least one connection identifier to a linked D2D terminal The link identifier and the at least one connection identifier can be transmitted in a manner of being included in a header of the data. The link ID may correspond to a unique identifier within a coverage of the two D2D terminals. The link ID can be configured by a combination of identifiers of the two D2D terminals. The connection identifier may correspond to a connection ID (CID), a flow identifier (FLOW ID), a logical channel identifier (LCID) or a DRB (data radio bearer) ID. The link ID can be implicitly configured by a predefined link ID according to a signal position within a discovery slot of the two D2D terminals. The link ID may correspond to a link ID assigned by a base station in a manner that the D2D terminal makes a request for a link ID to be used between the two D2D terminals to the base station.

To further achieve these and other advantages and in accordance with the purpose of the present invention, a method of receiving a data by a D2D terminal in a wireless communication system supporting a device-to-device (D2D) communication, the method includes the steps of receiving a data including a link identifier and at least one connection identifier from a linked D2D terminal and identifying the linked D2D terminal based on the link identifier and a flow corresponding to the connection identifier using the at least one connection identifier.

To further achieve these and other advantages and in accordance with the purpose of the present invention, a D2D terminal of transmitting a data in a wireless communication system supporting a device-to-device (D2D) communication includes a processor configured to establish a link identifier (link ID) between two D2D terminals and at least one connection identifier between the two D2D terminals; and

a transmitter configured to transmit the data including the established link identifier and the at least one connection to a linked D2D terminal

To further achieve these and other advantages and in accordance with the purpose of the present invention, a D2D terminal of receiving a data in a wireless communication system supporting a device-to-device (D2D) communication includes a receiver configured to receive a data including a link identifier and at least one connection identifier from a linked D2D terminal and a processor configured to identify the linked D2D terminal based on the link identifier and a flow corresponding to the connection identifier using the at least one connection identifier.

### Advantageous Effects

According to embodiments of the present invention, utilization efficiency of a system resource is enhanced in a D2D communication system, thereby increasing system performance.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram for a configuration of a base station 105 and a user equipment 110 in a wireless communication system 100;

FIGS. 2a and FIG. 2b are diagrams for explaining examples of a network concentrated D2D communication type corresponding to a network cooperative D2D communication type and a distributed D2D communication type, respectively;

FIG. 2c is a diagram for explaining an example of a concept of an autonomous D2D communication type;

FIG. 3 is a diagram for an example of a frame structure applicable to an autonomous D2D communication type;

FIG. 4 is a diagram for explaining an example for a D2D terminal to broadcast a peer discovery signal;

FIG. 5 is a diagram for explaining an example of a process for a transmission D2D terminal and a reception D2D terminal to occupy a traffic slot;

FIG. 6 is a diagram for explaining a connection scheme which is applied between terminals;

FIG. 7 is a diagram for explaining a link ID configuration between D2D terminals;

FIG. 8(a) and (b) are diagrams for discovery slots discovered by a D2D terminal A and a D2D terminal B, respectively and FIG. 8(c) is a diagram for a location scenario of terminals situating in the vicinity of a D2D terminal A and a D2D terminal B;

FIG. 9A is a diagram for a MAC data structure including a MAC header in LTE system;

FIG. 9B is a diagram for a MAC data structure including a MAC header in IEEE 802.16m system;

FIG. 10 is a diagram for explaining an example of a method of transmitting data using multiple CIDs;

FIG. 11 is a diagram for explaining an example of a method of transmitting channel state information using a link ID or a CID;

FIG. 12A is a diagram for explaining a method of performing data communication between legacy terminals and FIG. 12B is a diagram for explaining a method of performing data communication between D2D terminals.

### BEST MODE MODE FOR INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes 3GPP LTE/LTE-A system, they are applicable to other random mobile communication systems except unique features of 3GPP LTE/LTE-A system.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS), and the like. And, assume that a base station is a common name of such a random node of a network stage communicating with a terminal as a Node B, an eNode B, a base station (BS), an access point (AP) and the like. Although the present specification is explained on the basis of IEEE 802.16 system, contents of the present invention can also be applied to various communication systems except the IEEE 802.16 system.

In a mobile communication system, a user equipment may be able to receive information from a base station in downlink and transmit the information to the base station in uplink. The informations transmitted or received by user equipment may include data and various control informations. And, various kinds of physical channels may exist in accordance with types and usages of the informations transmitted or received by the user equipment.

The following description of embodiments of the present invention may be usable for various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3^{rd} Generation Partnership Project) LTE (long term evolution) is a part of E-UMTS (Evolved UMTS) that uses E-UTRA. The 3GPP LTE adopts OFDMA in downlink (hereinafter abbreviated DL) and SC-FDMA in uplink (hereinafter abbreviated UL). And, LTE-A (LTE-Advanced) is an evolved version of 3GPP LTE.

Specific terminologies used in the following description are provided to help understand the present invention. The use of the specific terminology can be modified into a different form in a range of not deviating from the technical idea of the present invention.

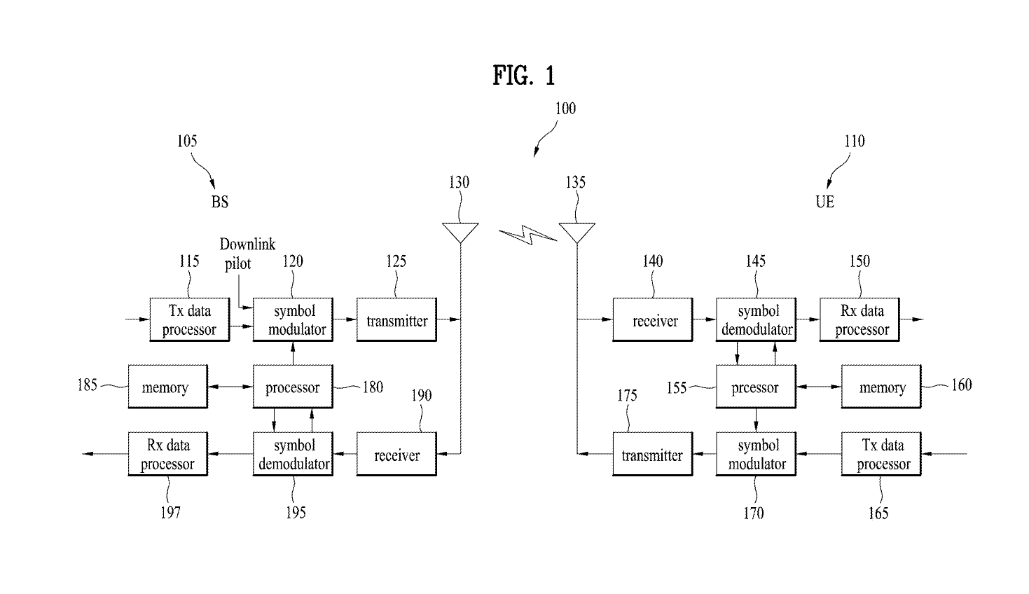

FIG. 1 is a block diagram for a configuration of a base station 105 and a user equipment 110 in a wireless communication system 100.

Although one base station 105 and one user equipment 110 are shown in the drawing to schematically represent a wireless communication system 100, the wireless communication system 100 may include at least one base station and/or at least one user equipment.

Referring to FIG. 1, a base station 105 may include a transmitted (Tx) data processor 115, a symbol modulator 120, a transmitter 125, a transceiving antenna 130, a processor 180, a memory 185, a receiver 190, a symbol demodulator 195 and a received data processor 197. And, a user equipment 110 may include a transmitted (Tx) data processor 165, a symbol modulator 170, a transmitter 175, a transceiving antenna 135, a processor 155, a memory 160, a receiver 140, a symbol demodulator 155 and a received data processor 150. Although the base station/user equipment 105/110 includes one antenna 130/135 in the drawing, each of the base station 105 and the user equipment 110 includes a plurality of antennas. Therefore, each of the base station 105 and the user equipment 110 according to the present invention supports an MIMO (multiple input multiple output) system. And, the base station 105 according to the present invention may support both SU-MIMO (single user-MIMO) and MU-MIMO (multi user-MIMO) systems.

In downlink, the transmitted data processor 115 receives traffic data, performs coding on the received traffic data by formatting, interleaves the coded traffic data, modulates (or symbol maps) the interleaved data, and then provides modulated symbols (data symbols). The symbol modulator 120 provides a stream of symbols by receiving and processing the data symbols and pilot symbols.

The symbol modulator 120 multiplexes the data and pilot symbols together and then transmits the multiplexed symbols to the transmitter 125. In doing so, each of the transmitted symbols may include the data symbol, the pilot symbol or a signal value of zero (i.e., null). In each of symbol durations, pilot symbols may be contiguously transmitted. In doing so, the pilot symbols may include symbols of frequency division multiplexing (FDM), orthogonal frequency division multiplexing (OFDM), time division multiplexing (TDM), or code division multiplexing (CDM).

The transmitter 125 receives the stream of the symbols, converts the received stream to at least one or more analog signals, additionally adjusts the analog signals (e.g., amplification, filtering, frequency upconverting, etc.), and then generates a downlink signal suitable for a transmission on a radio channel. Subsequently, the downlink signal is transmitted to the user equipment via the transmitting antenna 130.

In the configuration of the user equipment 110, the receiving antenna 135 receives the downlink signal from the base station and then provides the received signal to the receiver 140. The receiver 140 adjusts the received signal (e.g., filtering, amplification and frequency downconverting), digitizes the adjusted signal, and then obtains samples. The symbol demodulator 145 demodulates the received pilot symbols and then provides them to the processor 155 for channel estimation.

The symbol demodulator 145 receives a frequency response estimated value for downlink from the processor 155, obtains data symbol estimated values (i.e., estimated values of the transmitted data symbols) by performing data modulation on the received data symbols, and then provides the data symbol estimated values to the received (Rx) data processor 150. The received data processor 150 reconstructs the transmitted traffic data by performing demodulation (i.e., symbol demapping, deinterleaving and decoding) on the data symbol estimated values.

The processing by the symbol demodulator 145 and the processing by the received data processor 150 are complementary to the processing by the symbol modulator 120 and the processing by the transmitted data processor 115 in the base station 105, respectively.

Regarding the user equipment 110 in uplink, the transmitted data processor 165 provides data symbols by processing the traffic data. The symbol modulator 170 provides a stream of symbols to the transmitter 175 by receiving the data symbols, multiplexing the received data symbols, and then performing modulation on the multiplexed symbols. The transmitter 175 generates an uplink signal by receiving the stream of the symbols and then, processing the received stream. The generated uplink signal is then transmitted to the base station 105 via the transmitting antenna 135.

In the base station 105, the uplink signal is received from the user equipment 110 via the receiving antenna 130. The receiver 190 obtains samples by processing the received uplink signal. Subsequently, the symbol demodulator 195 provides pilot symbols received in uplink and a data symbol estimated value by processing the obtained samples. The received data processor 197 reconstructs the traffic data transmitted from the user equipment 110 by processing the data symbol estimated value.

The processor 155/180 of the user equipment/base station 110/105 directs operations (e.g., control, adjustment, management, etc.) of the user equipment/base station 110/105. Each of the processor 155/180 may be connected to the memory unit 160/185 configured to store program codes and data. The memory 160/185 is connected to the processor 180 to store operating systems, applications and general files.

The processor 155/180 may be called one of a controller, a microcontroller, a microprocessor, a microcomputer and the like. And, the processor 155/180 may be implemented using hardware, firmware, software and/or any combinations thereof In the implementation by hardware, the processor 155/180 may be provided with one of ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 155/180 or saved in the memory 160/185 to be driven by the processor 155/180.

Layers of a radio protocol between a user equipment and a base station may be classified into 1^{st} layer (L1), 2^{nd} layer (L2) and 3^{rd} layer (L3) based on 3 lower layers of OSI (open system interconnection) model well known to communication systems. A physical layer belongs to the 1^{st} layer and provides an information transfer service via a physical channel. RRC (radio resource control) layer belongs to the 3^{rd} layer and provides control radio resources between UE and network. A user equipment and a base station may be able to exchange RRC messages with each other via a radio communication network using RRC layers.

In the present specification, the processor 155 of the user equipment and the processor 180 of the base station perform an operation of processing a signal and data except a function of receiving or transmitting a signal performed by the user equipment 110 and the base station 105, respectively. Yet, for clarity, the processor 155/180 is not separately mentioned in the following description. Although there is no special citation for the processor 155/180, the processor can perform a series of operations including data processing, control and the like instead of transmitting or receiving a signal.

In the following description, various embodiments including device-to-device communication between terminals (hereinafter abbreviated D2D communication, D2D direct communication or the like) performed by a terminal is explained. In explaining the D2D communication, although 3GPP LTE/LTE-A is explained as an example for detail explanation, the D2D communication can be used in a manner of being applied to a different communication system (e.g., IEEE 802.16, WiMAX and the like).

For clarity, a terminal performs or capable of performing the D2D communication, which is a direct communication between terminals, is called a D2D terminal (D2D terminal). When it is necessary to distinguish a transmitting end and a receiving end from each other, in case of performing the D2D communication, a D2D terminal transmits or intends to transmit data to a different D2D terminal using a radio resource given to a D2D link is called a transmission D2D terminal On the contrary, a terminal receives or intends to receive data from the transmission D2D terminal is called a reception D2D terminal If there exist a plurality of reception D2D terminals, which receive or intend to receive data from the transmission D2D terminal, a plurality of the reception D2D terminals can be distinguished from each other using a prefix such as ‘first to N’. Moreover, for clarity, such a random node of a network as a base station used for performing access control between D2D terminals or allocating a radio resource to a D2D link, a D2D server, an access/session management server and the like are commonly called a ‘network’ in the following description.

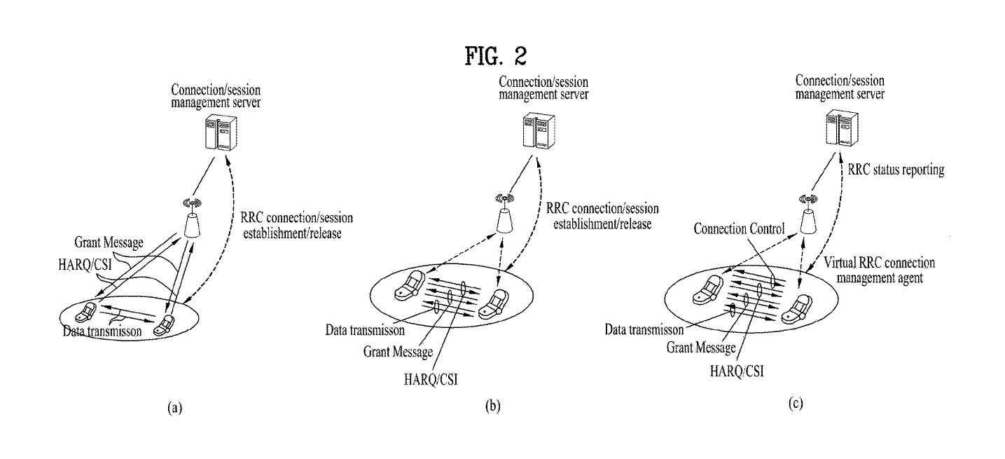

FIG. 2 is a diagram for explaining various embodiments of a D2D communication.

D2D communication can be classified into a network coordinated D2D communication type and an autonomous D2D communication type according to whether a D2D communication is performed by a control of a network. The network coordinated D2D communication type can be classified again into a type of transmitting data only by D2D (data only in D2D) and a type of performing an access control only by a network (connection control only in network) according to the extent of involvement of the network. For clarity, the type of transmitting data only by the D2D is called a ‘network concentrated D2D communication type’ and the type of performing access control only by the network is called a ‘distributed D2D communication type’ in the following.

FIGS. 2a and FIG. 2b are diagrams for explaining examples of a network concentrated D2D communication type corresponding to a network cooperative D2D communication type and a distributed D2D communication type, respectively.

According to the network concentrated D2D communication type shown in FIG. 2a, data is exchanged between D2D terminals only. An access control (connection control) and radio resource allocation (grant message) between the D2D terminals are performed by a network. The D2D terminals can transmit and receive data or specific control information using a radio resource allocated by the network.

For instance, HARQ ACK/NACK feedback for the data reception between the D2D terminals or channel state information (CSI) is not directly exchanged between the D2D terminals. Instead, the feedback or the CSI can be transmitted to a different D2D terminal via the network. Specifically, when the network establishes a D2D link between the D2D terminals and allocates a radio resource to the established D2D link, a transmission D2D terminal and a reception D2D terminal can perform D2D communication using the allocated radio resource.

In particular, according to the network concentrated D2D communication type, D2D communication between D2D terminals is controlled by the network and the D2D terminals can perform D2D communication using a radio resource allocated by the network.

A network according to the distributed D2D communication type shown in FIG. 2b performs a more limitative role compared to a network according to the network concentrated D2D communication type. Although the network in the distributed D2D communication type performs an access control between D2D terminals, radio resource allocation (grant message) between the D2D terminals can be occupied by the D2D terminals themselves via competition without a help of the network.

For instance, HARQ ACK/NACK feedback for the reception of data between the D2D terminals or channel state information can be directly exchanged between the D2D terminals without passing through the network.

As mentioned earlier in the foregoing example, D2D communication can be classified into the network concentrated D2D communication type and the distributed D2D communication type according to the extent of involvement of a network. In this case, a common characteristic between the network concentrated D2D communication type and the distributed D2D communication type is a D2D access control capable of being performed by the network.

Specifically, a network according to the network coordinated D2D communication type can establish a connection between D2D terminals in a manner of establishing a D2D link between the D2D terminals intending to perform D2D communication. In case of establishing the D2D link between the D2D terminals, the network can assign a physical D2D link identifier (LID) to the established D2D link. The physical D2D link ID can be used as an identifier identifying each of a plurality of D2D links in case that there are a plurality of the D2D links between a plurality of D2D terminals.

FIG. 2c is a diagram for explaining an example of a concept of an autonomous D2D communication type.

Unlike the network concentrated type and the distributed D2D communication type, according to an autonomous D2D communication type, D2D terminals can freely perform D2D communication without a help of a network. In particular, unlike the network concentrated type and the distributed D2D communication type, an access control, occupation of a radio resource and the like can be performed by the D2D terminals by themselves in the autonomous D2D communication type. If necessary, the network may provide the D2D terminals of D2D channel information capable of being used in a corresponding cell.

The autonomous D2D communication type is explained in more detail based on a frame structure described in the following.

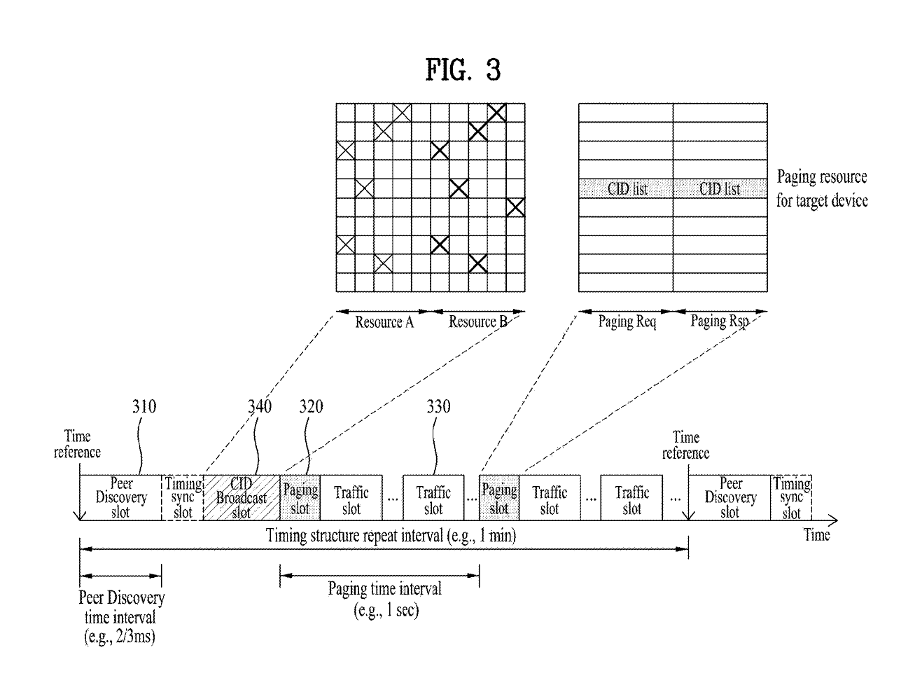

FIG. 3 is a diagram for an example of a frame structure applicable to an autonomous D2D communication type.

In particular, a D2D terminal can perform D2D communication using a frame shown in FIG. 3 in the autonomous D2D communication type. As shown in an example of FIG. 3, the frame applicable to the autonomous D2D communication type may include a peer discovery slot 310, a paging slot 320 and a traffic slot 330. In some cases, the frame applicable to the autonomous D2D communication type may further include a CID (connection identifier) broadcast slot 340.

The peer discovery slot 310 is an interval configured for a D2D terminal to detect a different D2D terminal around the D2D terminal and broadcast existence of the D2D terminal to the different D2D terminal around the D2D terminal One peer discovery slot 310 includes a plurality of logical channels. The D2D terminal can share the peer discovery slot 310 with the different D2D terminal via broadcasting and listening. In particular, the D2D terminal can recognize which logical channel is in use or which logical channel is empty among a plurality of the logical channels of the peer discovery slot 310 in a manner of listening to a logical channel occupied by the different D2D terminal from the different D2D terminal around the D2D terminal. In some cases, a range of the D2D terminal capable of listening to a broadcast may be restricted to a neighboring D2D terminal situating within one hop on the basis of the D2D terminal. Yet, it may be not mandatory to limit the range of the D2D terminal capable of listening to a broadcast on the neighboring D2D terminal situating within one hop of the D2D terminal.

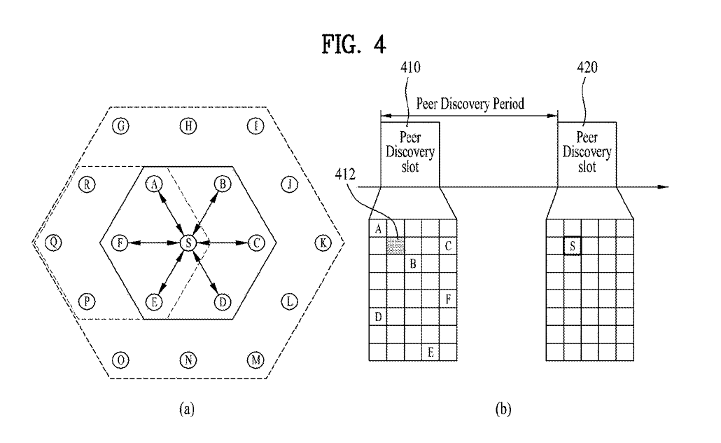

Having listened to the logical channel occupied by the different D2D terminal from the different D2D terminal, the D2D terminal can randomly select a logical channel among empty logical channels from a first peer discovery slot 310. Subsequently, the D2D terminal can broadcast a peer discovery signal configured to notify the logical channel selected by the D2D terminal on the selected logical channel via a next peer discovery slot. In relation to broadcasting the peer discovery signal broadcasted by the D2D terminal, it shall be explained in more detail with reference to FIG. 4 in the following.

FIG. 4 is a diagram for explaining an example for a D2D terminal to broadcast a peer discovery signal.

First of all, as shown in FIG. 4(a), assume that there exist a D2D terminal A (represented by A) to a D2D terminal R (represented by R) around a D2D terminal S (represented by S). In this case, the D2D terminal A to a D2D terminal F (represented by F) correspond to neighboring terminals situating within one hop on the basis of the D2D terminal S. A D2D terminal G (represented by G) to the D2D terminal R correspond to neighboring terminals situating within 2 hops on the basis of the D2D terminal S.

In environment shown in FIG. 4(a), if a D2D terminal is able to listen to a broadcast broadcasted by neighboring D2D terminals within 1 hop, the D2D terminal S may be able to listen to logical channels occupied by the D2D terminal A to the D2D terminal F during a first peer discovery slot 410. Having listened to the logical channels occupied by the D2D terminal A to the D2D terminal F, the D2D terminal S can randomly select a logical channel among empty channels from the peer discovery slot based on the listened up broadcast (in FIG. 4(b), a logical channel 412). Subsequently, as shown in an example of FIG. 4(b), the D2D terminal S (represented by S) can broadcast a peer discovery signal using a logical channel randomly selected from a second peer discovery slot 420.

The D2D terminal A to F listening to the logical channel, which is selected by the D2D terminal S, can detect whether the logical channel selected by the D2D terminal S is collided or not. As an example, the D2D terminal F listening to broadcasting broadcasted by the D2D terminal A, E, P or R can detect whether the logical channel selected by the D2D terminal S is collided with a logical channel of the D2D terminal A, E, P or R. If the logical channel selected by the D2D terminal S is collided with a logical channel of the D2D terminal Q, the D2D terminal F transmits a notification signal notifying that a logical channel collision is detected to the D2D terminal S and the D2D terminal S may be then able to select a new logical channel according to the notification signal.

On the contrary, if the logical channel selected by the D2D terminal S is not collided, the D2D terminal can consistently broadcast a peer discovery signal on the selected logical channel.

If it is determined that the logical channel selected by the D2D terminal S is collided with a logical channel occupied by the neighboring D2D terminal Q, the D2D terminal F transmits a notification signal notifying that a collision is detected to the D2D terminal S and the D2D terminal S may be then able to select a new logical channel.

The CID broadcast slot 340 shown in FIG. 3 is configured for a D2D terminal to listen to a CID in use by a different D2D terminal and broadcast a CID in use by the D2D terminal Specifically, in order for the D2D terminal to inform a CID in use or a CID to be used, the D2D terminal can broadcast a CID broadcast signal via a CID resource of the CID broadcast slot 340. The D2D terminal can configure the CID to be used via a paging slot 320 described in the following.

The paging slot 320 shown in FIG. 3 is configured to establish (or set) a CID between a transmission D2D terminal and a reception D2D terminal The paging slot 320 configured to set the CID may include a paging request interval and a paging response interval. In order to set the CID between the transmission D2D terminal and the reception D2D terminal, one of the transmission D2D terminal and the reception D2D terminal operates as a paging initiator terminal and another one may operate as a paging target terminal.

The paging initiator terminal can generate a first CID list including at least one empty broadcast resource (i.e., a CID not in use) based on the CID listened up via the CID broadcast slot 340. If the first CID list is generated, the paging initiator terminal can transmit the first CID list to the paging target terminal using a paging resource of the paging initiator terminal or that of the paging target terminal

In this case, the paging resource can be determined by a device identifier (ID) of the paging initiator terminal or that of the paging target terminal The paging resource between D2D terminals can be distinguished from each other by time-frequency or an orthogonal code, by which the present invention may be non-limited.

During the paging response interval, the paging target terminal generates a second CID list including at least one empty resource based on the CID listened up via the CID broadcast slot 340 and may be then able to transmit the second CID list to the paging initiator terminal using a paging resource of the paging target terminal or that of the paging initiator terminal.

The paging initiator terminal and the paging target terminal sort out available candidate CIDs based on the first CID list and the second CID list and select one from the available candidates CIDs. In order to notify the selected CID, the paging initiator terminal and the paging target terminal can broadcast a CID broadcast signal via a CID resource of a CID broadcast slot 440.

Subsequently, the paging initiator terminal and the paging target terminal can determine whether a CID selected by a next CID broadcast slot 340 is in use by a different D2D terminal Specifically, the paging initiator terminal and the paging target terminal compare signal strength of CID resources different from each other with each other for an identical tone and may be then able to determine whether the selected CID is in use by the different D2D terminal.

If it is determined that the selected CID is in use, the paging initiator terminal and the paging target terminal can reselect a different CID. On the contrary, if it is determined that the selected CID is not in use, the paging initiator terminal and the paging target terminal can activate the selected CID. The selected CID can be configured as a CID between the paging initiator terminal and the paging target terminal only when both the paging initiator terminal and the paging target terminal activate the selected CID.

Unlike the aforementioned network concentrated D2D communication type and the distributed D2D communication type, a D2D terminal according to the autonomous D2D communication type performs an access control with a different D2D terminal by itself instead of establishing a D2D link by a network. Hence, according to the autonomous D2D communication type, a network cannot allocate a D2D link ID to the D2D terminal. Instead of the D2D link ID, the D2D terminal can perform D2D communication in a manner of configuring a CID with a different D2D terminal via a paging slot 320 in the autonomous D2D communication type.

If a CID configuration is completed between a transmission D2D terminal and a reception D2D terminal via the paging slot 320, the transmission D2D terminal and the reception D2D terminal can perform data transmission and reception using a traffic slot 330. In this case, the transmission D2D terminal and the reception D2D terminal can occupy the traffic slot 330 via competition with a different D2D link. If the traffic slot 330 is occupied, the transmission D2D terminal and the reception D2D terminal can transmit and receive data using the occupied traffic slot 330.

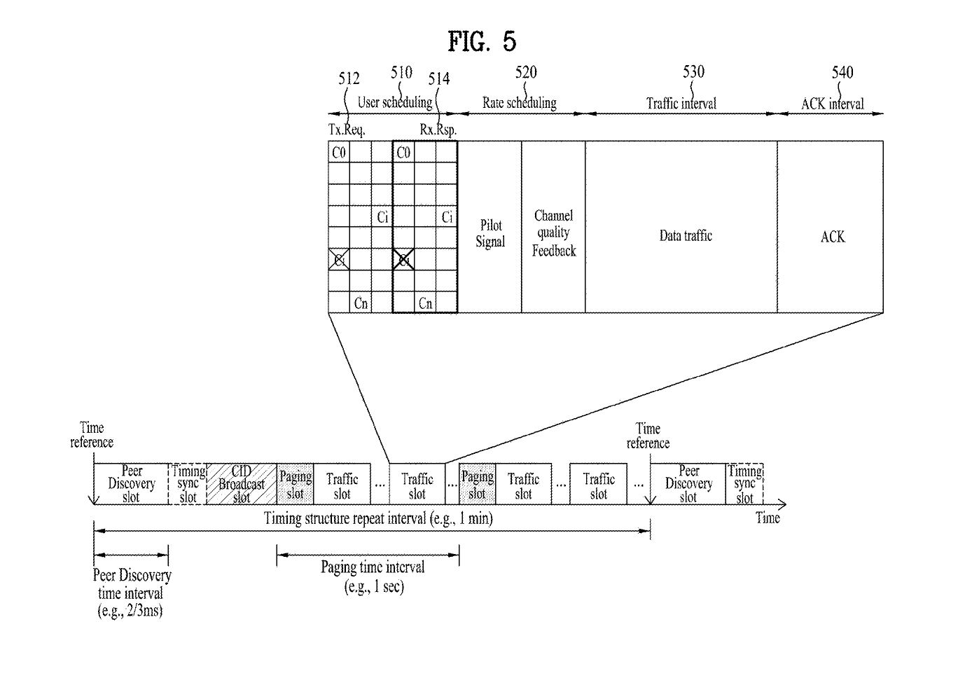

In relation to occupying the traffic slot 330 occupied by the transmission D2D terminal and the reception D2D terminal, it shall be explained in detail with reference to FIG. 5 in the following.

FIG. 5 is a diagram for explaining an example of a process for a transmission D2D terminal and a reception D2D terminal to occupy a traffic slot.

Referring to FIG. 5, a traffic slot 330 can include a user scheduling interval 510, a rate scheduling interval 520, a traffic interval 530 and an ASK interval 540.

The user scheduling interval 510 is configured for a transmission D2D terminal and a reception D2D terminal to transmit and receive a signal to occupy a corresponding traffic slot. The user scheduling interval can include a transmission request interval (Tx Req) 512 and a reception response interval (Rx Res) 514. First of all, the transmission D2D terminal can transmit a request signal to the reception D2D terminal via a resource corresponding to a CID selected by using a CID selected via a paging slot 320 during the transmission request interval 512.

The reception D2D terminal sharing an identical CID with the transmission D2D terminal receives the request signal and if the reception D2D terminal determines that it is feasible to transmit data according to a predetermined competition rule, the reception D2D terminal can transmit a response signal to the transmission D2D terminal via a resource corresponding to the CID during the response interval 514.

Having successfully received the request signal and the response signal, the transmission D2D terminal and the reception D2D terminal can determine it as a corresponding traffic slot 330 is occupied. If it is determined that the traffic slot 330 is occupied, the transmission D2D terminal can transmit a pilot signal (or a reference signal) to the reception D2D terminal during the rate scheduling interval 520. Having received the pilot signal from the transmission D2D terminal, the reception D2D terminal can identify a channel state for the pilot signal. In particular, the reception D2D terminal identifies the channel state (CQI (channel quality information), CSI (channel state information), SINR (signal to interference plus noise ratio) and the like) with reference to the pilot signal or the reference signal transmitted by the transmission D2D terminal and may be then able to feedback the channel state to the transmission D2D terminal which has transmitted the pilot signal.

Having received the channel state from the reception D2D terminal, the transmission D2D terminal can determine whether to transmit data to the reception D2D terminal using a D2D traffic resource during the traffic interval 530 based on the channel state. For instance, if a measured CQI or SINR is smaller or lower than a predetermined threshold, the transmission D2D terminal does not transmit data during the traffic interval and may try to occupy a next traffic slot 330.

If the transmission D2D terminal transmits data during the traffic interval using a traffic resource, the reception D2D terminal can transmit ACK or NACK via the ACK interval 540 in accordance with whether the data is successfully received.

Terminologies used in the description of the present specification can be used by meanings described in the following in general.

A link ID (LID) corresponds to an identifier set to a connection to identify each terminal The link ID corresponds to an identifier allocated to a physical connection and the ID unique in a specific region. For instance, the link ID includes an STID (station identifier) in IEEE 802.16 system and C-RNTI (cell radio network temporary identifier) in LTE system.

A connection ID (CID) corresponds to an identifier allocated to one or more service flows capable of being configured between terminals. For instance, the connection ID may correspond to a connection ID on a MAC layer of IEEE 802.16e system, a flow ID on a MAC layer of IEEE 802.16m system, a logical channel ID (LCID) in LTE, or a DRB identity. In particular, the connection ID corresponds to a LCID on MAC layer or a DRB (data radio bearer) ID on RLC layer.

The link ID or the connection ID used in the present invention can be configured as a bi-directional ID or a one-way ID. In particular, when the link ID or the connection ID is configured as the bi-directional ID, the configured link/connection ID means that both terminals can play a role of a transmitter and a role of a receiver and data transceived between the two terminals can use one link/connection ID. Yet, when the link ID or the connection ID is configured as the one-way ID, the configured link/connection ID means that an initiating terminal, which has initiated a link or a connection, becomes a transmission terminal (or a source terminal) and a target terminal becomes a reception terminal If the target terminal has data to transmit to the source terminal, the target terminal can transmit the data using an additional link/connection ID in a manner of configuring a new link/connection.

In the following, a CID scheme is explained in case that there are one or more connections between two terminals. According to the related art, each of all connections used to be treated as an independent connection.

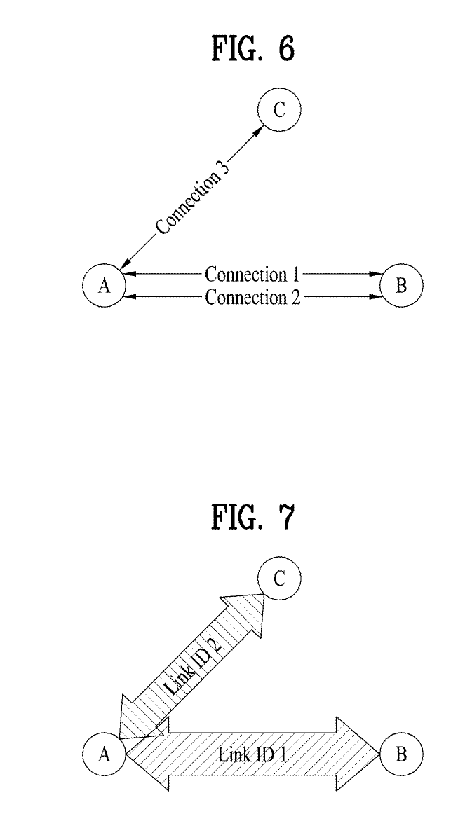

FIG. 6 is a diagram for explaining a connection scheme which is applied between terminals.

Referring to FIG. 6, there are two active connections (i.e., a connection 1 and a connection 2) between a terminal A (represented by A) and a terminal B (represented by B) and there is one active connection (i.e., a connection 3) between the terminal A and a terminal C. Conventionally, as shown in FIG. 6, the terminal A, the terminal B and the terminal C were not aware that there are 3 active connections around each of the terminals and each connection is used for which terminal except the connection connected to each of the terminal A, the terminal B and the terminal C. Hence, although there are connections connected for an identical terminal, the connections are recognized as connections connected for terminals different from each other and the connections are treated as an independent connection, respectively.

In particular, in case that a CID 1 occupies a traffic slot to transmit data for a connection 1 between the terminal A and the terminal B, the traffic slot is occupied using CIDs assigned to the connection 1 between the terminal A and the terminal B. Subsequently, a rate scheduling (Tx pilot transmission and reception feedback (CQI) transmission) between the terminal A and the terminal B is performed.

Yet, since the amount of data for the connection 1 between the terminal A and the terminal B may be less and, although data for a connection 2 between the terminal A and the terminal B is standby in a buffer at the same time, a corresponding traffic slot is occupied by a resource for the connection 1, a next traffic slot or an interval should be newly occupied by competition to transmit the data for the connection 2.

In case of data for connections different from each other while source/destination is identical to each other, a D2D traffic slot can be more efficiently used in case that data capable of being transmitted using a traffic slot occupied between the two terminals is transmitted in concatenated manner. Hence, it is necessary to define a method of efficiently using the D2D traffic slot. Information necessary for performing communication between D2D terminals according to an autonomous D2D communication type system may include channel state information between the D2D terminals and physical information such as distance and the like. This value is identically maintained as long as there exists a connection with a specific D2D terminal.

Although connections different from each other are configured between two D2D terminals, physical information (channel state information, a distance value and the like) measured between the two D2D terminals is maintained by an identical value for the connections different from each other. If there are n number of connections between the D2D terminals, identical information transmission/procedure is performed n times despite the physical information can be transmitted one time only between the D2D terminals, thereby decreasing whole system performance.

According to the related art, although there is a connection connected in advance between terminals, if a new connection is added between the terminals, a CID should be newly configured by repeatedly performing a CID configuration process for the added connection. Despite that there is a connection 1 configured between a terminal A and a terminal B, it is required to perform a basic D2D procedure such as discovery or paging between the two terminals. This content is applied to D2D communication as well. Unnecessary resource use or an additional procedure is performed between D2D terminals performing the D2D communication. It may become a factor deteriorating whole system performance.

Hence, the present specification proposes a method of assigning a connection identifier (e.g., a connection ID, a link ID or a flow ID) enabling a D2D communication to be efficiently performed in a wireless communication system (e.g., D2D or P2P system) supporting a direct communication between terminals.

Link ID Between D2D Terminals

A technology of the present invention proposes to set and use a link ID configured to distinguish links between D2D terminals from each other before distinguishing at least one connection set between the D2D terminals.

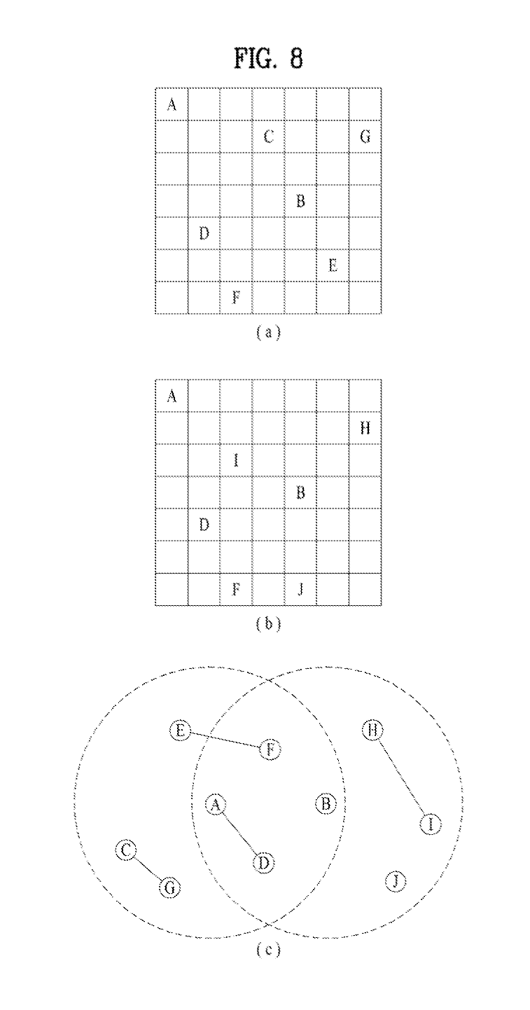

FIG. 7 is a diagram for explaining a link ID configuration between D2D terminals.

Referring to FIG. 7, although there exist a connection 1 and a connection 2 between a D2D terminal A (represented by A) and a D2D terminal B (represented by B), both the connection 1 and the connection 2 are recognized as a link ID 1 between the D2D terminal A and the D2D terminal B only. Connections set between the D2D terminal A and a D2D terminal C (represented by C) can be configured as a link ID 2. And, a link ID should be a unique value within coverage of the two D2D terminals in a D2D communication system. The link ID can be configured by one of methods described in the following.

1. A D2D terminal monitors a discovery slot, performs paging (In this case, it is preferable that the paging means a procedure to awake a counterpart node by fast paging and receive an awake response from the counterpart node only) and monitors LID broadcast. In particular, the LID broadcast monitoring is performed by the D2D terminal in a LID broadcast slot to listen to a LID in use by a different D2D terminal and broadcast a LID in use by the D2D terminal Subsequently, the D2D terminal transmits a LID not in use and may be then able to set a link ID by receiving a selected LID.

2. A D2D terminal monitors a discovery slot, performs paging (In this case, it is preferable that the paging means a procedure to awake a counterpart node by fast paging and receive an awake response from the counterpart node only) and can set a link ID predefined between two nodes.

The present invention proposes to use a LID to occupy traffic between two nodes and transmit physical information (e.g., channel state information, HARQ, power control-related information and the like).

Setup a Connection ID Between D2D Terminals

If there exists one or more connections between two D2D terminals, it is necessary to have a method of distinguishing the one or more connections from each other in order to use a link ID used in the technology of the present invention. Since a single D2D terminal may have one or more links with one or more D2D terminals and may have multiple connections in the one or more links, it is necessary to have a method of distinguishing the multiple connections from each other in a MAC (medium access control) (or RLC (radio link control)) PDU (protocol data unit) header.

The present invention proposes to use a connection ID with which a link ID and a flow ID are combined in the MAC or the RLC PDU header (i.e., CID=LID (or source ID)+FID). Since a single D2D terminal may have a connection with one or more D2D terminals, it is necessary to include an identifier including both a counterpart D2D terminal and a flow ID with the counterpart D2D terminal in a header. In this case, for the CID, it may use a source or destination ID instead of the LID.

Link ID (LID) Setup Method 1

As a first LID setup method, an LID can be set by a combination of a source ID and a destination ID.

An LID is divided into a source ID and a destination ID. This may correspond to a source ID or a destination ID configured according to a position of a tone slot of each D2D terminal discovered on a discovery slot. Or, it may correspond to a unique identifier of a terminal transmitted from a beacon signal. In particular, it is preferable that a unique identifier of a terminal corresponds to a value unique between neighboring D2D terminals only in which signals of two D2D terminals are recognized. Or, the unique identifier of the terminal may correspond to a value globally unique in a D2D network or a MAC address.

As a second LID setup method, a predefined LID can be implicitly configured according to positions of two D2D terminal signals (e.g., tone or a beacon signal) in a discovery slot. In order to support the second method, the positions of the two D2D terminal signals in the discovery slot should be designed not to be collided with each other between neighboring D2D terminals.

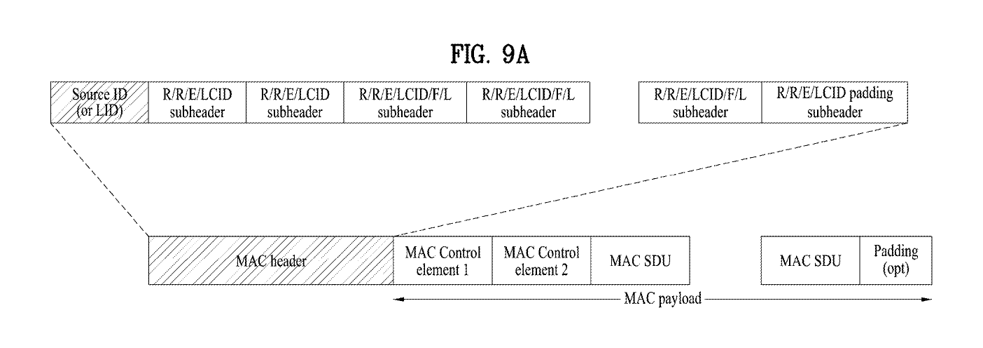

FIG. 8 is a diagram for explaining an example of the link ID setup method 1.

FIG. 8(a) and (b) are diagrams for discovery slots discovered by a D2D terminal A and a D2D terminal B, respectively and FIG. 8(c) is a diagram for a location scenario of terminals situating in the vicinity of a D2D terminal A and a D2D terminal B.

Referring to FIG. 8(a) and (b), although a D2D terminal G (represented by G) and a D2D terminal H (represented by H) use an identical signal slot, a D2D terminal F (represented by F) or a D2D terminal D (represented by D) cannot be connected with the D2D terminal G or the D2D terminal H (represented by H) at the same time. In particular, this means that either the D2D terminal G or the D2D terminal H can be searched only when the D2D terminal G or the D2D terminal H monitors a discovery slot of its own. The two D2D terminals become aware of the existence of one another via a discovery slot. Since the slot uses a tone slot not used by nodes around the two D2D terminals, an LID according to a position of the tone slot is unique around the two D2D terminals. In particular, a predefined LID is implicitly configured between nodes in a discovery interval according to a determined rule.

Link ID (LID) Setup Method 2

A legacy CID selection method can be used for an LID. Neighboring D2D terminals notify an LID in use via an LID broadcast interval. D2D terminals intending to configure a new LID select one LID among LIDs not in use in the LID broadcast interval. This can be done via a paging interval as well.

Link ID (LID) Setup Method 3

It may also consider a method of configuring an LID via a base station. An LID of two D2D terminals can be configured via a base station. When a source terminal receives a paging response from a target (or destination) terminal, the source terminal makes a request for an LID to be used between the two terminals to the base station. Then, the base station selects an LID not in use around the two terminals and may be then able to assign the LID to the two terminals.

Connection ID (CID) Setup Method

In case of a B2D system, if there is data transmitted by an ID (e.g., C-RNTI (cell-radio network temporary identifier) in LTE system, an STID (station identifier) in IEEE 802.16m system) of a terminal, the terminal receives the data and recognizes a connection for the data via a header. Since a transmitter is fixed to a base station (ABS or node-B), the terminal recognizes the connection for the data only after receiving the data transmitted to the terminal

Yet, in case of a D2D system, a D2D terminal recognizes data transmitted to the D2D terminal by a link ID (LID). Although the D2D terminal receives the data, since there may exist one or more transmitters transmitting the data, even though the data is received using a unique link ID (LID) between terminals, it is necessary to know a flow and a terminal, which has transmitted the data.

Hence, the technology of the present invention proposes to use not only a link ID but also a flow ID in a header. Embodiment of using not only the link ID but also the flow ID is explained in the following.

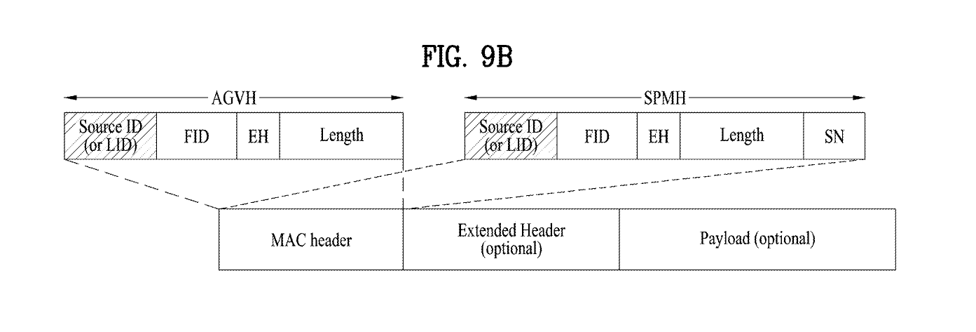

FIG. 9A is a diagram for a MAC PDU structure including a MAC header in LTE system.

Referring to FIG. 9A, a MAC PDU in LTE system includes a MAC header and a MAC payload. According to a legacy LTE system, a source ID (LID) is not transmitted in the MAC header. Yet, in D2D communication, it is necessary to include the source ID (LID) in case of transmitting the MAC header. In this case, in order for a D2D terminal to receive data in a D2D system, it is necessary for the MAC header to further include a link ID as well as a logical channel ID (LCID). In case of transmitting the MAC header in a manner of including a link ID and a flow ID in the MAC header, it is able to identify a flow and a D2D terminal, which has transmitted the data.

FIG. 9B is a diagram for a MAC PDU structure including a MAC header in IEEE 802.16m system.

Referring to FIG. 9B, a MAC header includes an advanced generic MAC header (AGMH) and a short packet MAC header (SPMH). The advanced generic MAC header (AGMH) and the short packet MAC header (SPMH) include a flow ID, respectively. Similarly, in order to know a flow and a D2D terminal, which has transmitted a data, in a D2D system, it is necessary to transmit the AGMH and the SPMH in a manner of further including a source ID (or LID) in the AGMH and the SPMH.

Data Transmission using Multiple CIDs

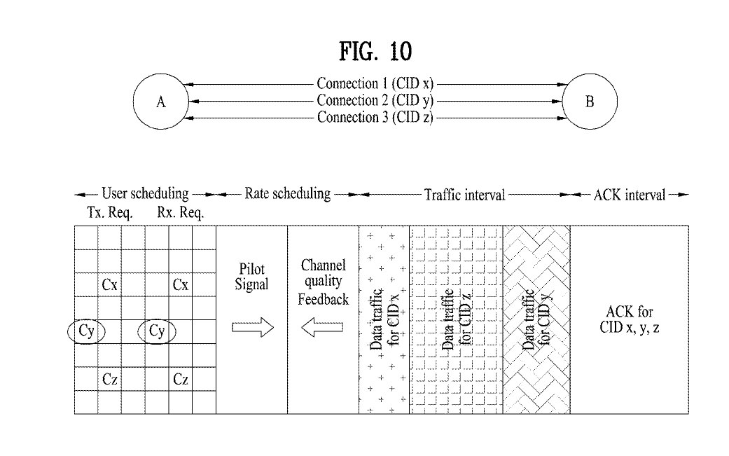

If there exist one or more connections between two D2D terminals, one or more CIDs configured with an identical terminal can be used as multiple CIDs in a link while using a legacy CID scheme. FIG. 10 is a diagram for explaining an example of a method of transmitting data using multiple CIDs.

As shown in FIG. 10, if there exist one or more connections between a D2D terminal A (represented by A) and a D2D terminal B (represented by B) and n number of CIDs are configured for the one or more connections, the D2D terminal A and B can use the n number of CIDs in case of transmitting and receiving data for n number of connections. And, the data for the n number of connections are freely transmitted and received via concatenation or packing according to a scheduling of a transmission D2D terminal in a traffic slot occupied for the n number of CIDs. In particular, a CID x, a CID y and a CID z correspond to IDs assigned to a connection 1, a connection 2 and a connection 3 between the D2D terminal A and the D2D terminal B. The D2D terminal A or the D2D terminal B can use all of the CID x, the CID y and the CID z to transmit data for the connection 1, the connection 2 and the connection 3. If one of the CID x, the CID y and the CID z occupies a traffic slot, the transmission D2D terminal can transmit the data for the connection 1, the connection 2 and the connection 3 using a resource of a corresponding traffic interval.

Method of Transmitting (e.g., Rate Scheduling) Channel State Information using Link ID or CID

According to a legacy scheme, a rate scheduling is performed for a CID (or LID) only, which has occupied a traffic slot in a user scheduling slot, and then data transmission and reception is performed. Yet, the present invention proposes to make D2D terminals transmit channel state information for a CID (or LID), which has not occupied a traffic slot, as well. By doing so, the channel state information between the D2D terminals can be periodically (or intermittently) transmitted. Hence, the channel state information can be used for a value for managing a currently connected connection and detecting a link failure in a manner of measuring a distance and a channel state between terminals and transmitting and receiving data.

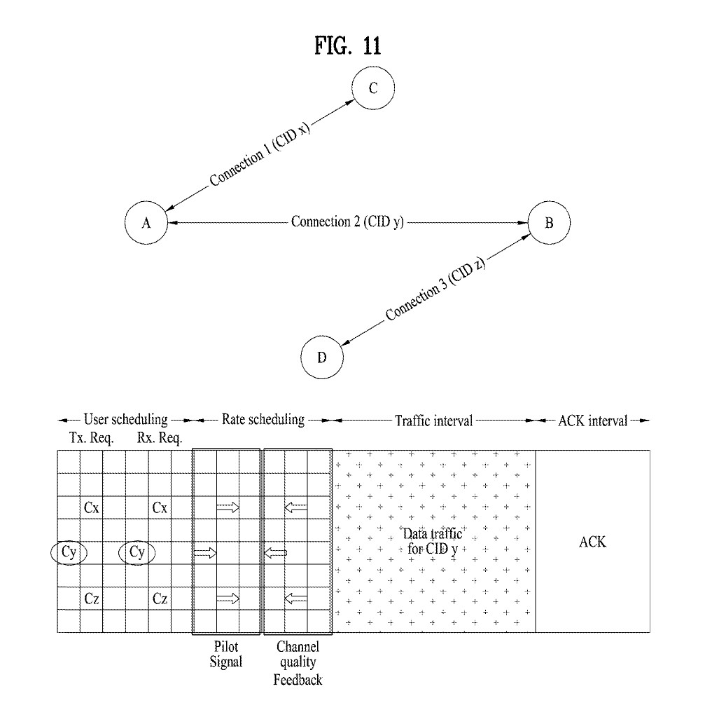

FIG. 11 is a diagram for explaining an example of a method of transmitting channel state information using a link ID or a CID.

Referring to FIG. 11, there exist a D2D terminal A (represented by A), a D2D terminal B (represented by B) and a D2D terminal C (represented by C). As shown in FIG. 11, if there exist 3 connections, although all of the 3 connections are trying to occupy a traffic slot, a CID y occupies a traffic interval only. In this case, according to the related art, a pilot is transmitted and a CQI feedback is received on a signal tone only corresponding to the CID y in rate scheduling. Yet, for a case mentioned above, a pilot signal for a CID x or a pilot signal for a CID z can be transmitted as well. This can be applied to not only a D2D terminal intending to occupy a traffic slot but also all terminals to which a CID (or LID) is assigned. In this case, the CID may correspond to a CID between D2D terminals identical to each other or a CID between D2D terminals different from each other. When it means a CID or an LID, corresponding channel state information is applied to a connection or a link not transmitted in a traffic interval.

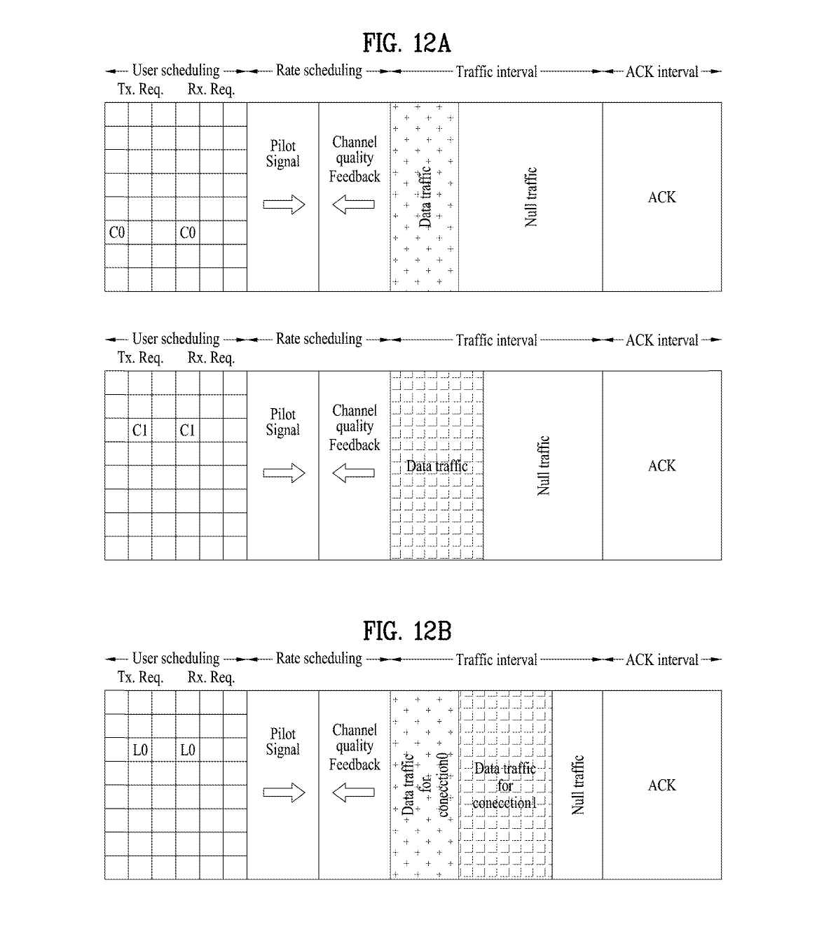

FIG. 12A is a diagram for explaining a method of performing data communication between legacy terminals and FIG. 12B is a diagram for explaining a method of performing data communication between D2D terminals.

Referring to FIG. 12A, a connection 0 (C0) and a connection 1 (C1) are configured between a terminal A and a terminal B. One connection is transmitted and received via a traffic interval between the terminal A and the terminal B and another connection is transmitted and received via a different traffic interval.

Meanwhile, referring to FIG. 12B, a link ID 0 is configured between the terminal A and the terminal B and a connection 0 (C0) and a connection 1 (C1) are configured between the terminal A and the terminal B. Scheduling for D2D data communication, which is performed for D2D communication, is performed according to a terminal link. By doing so, if there exist one or more connections between the terminals, user scheduling and rate scheduling, which are used to be performed as many as the number of connections, can be performed at a time. And, a transmitter can configure and transmit an amount of data to be transmitted during an occupied traffic slot according to QoS in accordance with a connection. Hence, a system resource utilization rate can be enhanced.

According to the embodiments of the present invention mentioned earlier in the foregoing description, a system resource utilization rate can be enhanced in a D2D communication system, thereby improving system performance.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, a method of transmitting and receiving data, which is transmitted and received by a D2D terminal in a wireless communication system supporting D2D communication, can be industrially applied to various mobile communication systems including 3GPP LTE, LTE-A system, IEEE 802 and the like.

What is claimed is:

1. A method of transmitting a data by a D2D terminal in a wireless communication system supporting a device-to-device (D2D) communication, the method comprising:
establishing a link identifier (link ID) between two D2D terminals and at least one connection identifier between the two D2D terminals; and
transmitting the data containing the established link identifier and the at least one connection identifier to a linked D2D terminal.

2. The method of claim 1, wherein the link identifier and the at least one connection identifier are transmitted in a manner of being contained in a header of the data.

3. The method of claim 1, wherein the link ID corresponds to a unique identifier within a coverage of the two D2D terminals.

4. The method of claim 1, wherein the link ID is configured by a combination of identifiers of the two D2D terminals.

5. The method of claim 1, wherein the connection identifier corresponds to a connection ID (CID), a flow identifier (FLOW ID), a logical channel identifier (LCID) or a DRB (data radio bearer) ID.

6. The method of claim 1, wherein the link ID is implicitly configured by a predefined link ID according to a signal position within a discovery slot of the two D2D terminals.

7. The method of claim 1, wherein the link ID corresponds to a link ID assigned by a base station in a manner that the D2D terminal makes a request for a link ID to be used between the two D2D terminals to the base station.

8. A method of receiving a data by a D2D terminal in a wireless communication system supporting a device-to-device (D2D) communication, the method comprising:
receiving a data containing a link identifier and at least one connection identifier from a linked D2D terminal; and
identifying the linked D2D terminal based on the link identifier and a flow corresponding to the connection identifier using the at least one connection identifier.

9. A D2D terminal of transmitting a data in a wireless communication system supporting a device-to-device (D2D) communication, the D2D terminal comprising:
a processor configured to establish a link identifier (link ID) between two D2D terminals and at least one connection identifier between the two D2D terminals; and
a transmitter configured to transmit the data containing the established link identifier and the at least one connection identifier to a linked D2D terminal

10. A D2D terminal of receiving a data in a wireless communication system supporting a device-to-device (D2D) communication, the D2D terminal comprising:
a receiver configured to receive a data containing a link identifier and at least one connection identifier from a linked D2D terminal; and
a processor configured to identify the linked D2D terminal based on the link identifier and a flow corresponding to the connection identifier using the at least one connection identifier.
